(19) United States
(12) Patent Application Publication
(10) Pub. No.: US 2018/0034592 A1
(43) Pub. Date: Feb. 1, 2018

(54) SYSTEMS AND METHODS FOR ROBUST DATA RETRANSMISSION

(71) Applicant: ZTE Wistron Telecom AB, Kista (SE)

(72) Inventors: Aijun CAO, Kista (SE); Yonghong GAO, Kista (SE); Jan JOHANSSON, Kista (SE)

(21) Appl. No.: 15/662,138

(22) Filed: Jul. 27, 2017

Related U.S. Application Data
(60) Provisional application No. 62/368,483, filed on Jul. 29, 2016.
(60) Provisional application No. 62/385,033, filed on Sep. 8, 2016.

(51) Int. Cl. H04L 1/00; H04L 5/22

(52) U.S. Cl. CPC H04L 1/0073; H04L 5/225; H04W 72/0413

(57) ABSTRACT

A system and method for robust data retransmission is disclosed. In one embodiment, a method performed by a first communication node includes: transmitting a first signal, the first signal comprising a transport block comprising a plurality of coding blocks; receiving a feedback signal, the feedback signal associated with a plurality of groups, each of the groups in the plurality of groups comprising at least one of the coding blocks; and puncturing at each of the groups in accordance with the feedback signal to produce a plurality of punctured groups.

### RELATED APPLICATIONS

This application claims priority to U.S. Provisional Application No. 62/368,483 entitled “METHOD FOR HIGH SPEED DATA RETRANSMISSION” filed on Jul. 29, 2016, the content of which is incorporated by reference herein in its entirety. This application also claims priority to U.S. Provisional Application No. 62/385,033 entitled “METHOD FOR HIGH SPEED DATA RETRANSMISSION” filed on Sep. 8, 2016, the content of which is incorporated by reference herein in its entirety.

### TECHNICAL FIELD

This disclosure relates generally to wireless communications and, more particularly, to systems and methods for robust data retransmission with high speed.

### BACKGROUND

Current mobile networks may be able to provide mobile users with data transmission service via almost ubiquitous radio access. However, users continue to demand higher and higher data rates. To meet user demand, different techniques have been developed to increase the data rate between the network and an individual user equipment (UE). Network densification is an example of one technique to increase the data rate. In network densification, a UE may have a shorter distance to base stations (B S) than techniques without network densification. Accordingly, network densification provides less path-loss of transmitted radio signals, which means more focused directional transmission of radio signals and more simultaneous data streams, all of which may increase the data rate.

In order to increase the reliability of data transmissions, reduce the impact of a hostile radio propagation environment, and lower the instantaneous transmission power at the transmitter side, a data retransmission mechanism known as HARQ (Hybrid Automatic Repeat reQuest) may be included in the MAC (Media Access Control) and PHY (Physical) layers.

FIG. 1 is a block diagram that illustrates principles of the HARQ data retransmission scheme (also termed more simply as a “HARQ scheme”). The HARQ scheme may be performed at the MAC layer. The HARQ scheme may pack each data stream to be transmitted in a transport block (TB) 102 as a basic unit for retransmission, which may also correspond to a radio frame or a sub frame. Also, one TB may be split into multiple coding blocks (CB) 104 which is the basic unit for coding and decoding. Also illustrated are blocks that represent rate matching 106, bit concatenation/interleaving 108, cyclic redundancy checks (CRC) 112 (which may be extra bits encoded with each of the TB 102 and the CBs 104 for error checking), and encoding 114. All of the above components may be part of a transmitter 116 (denoted with dotted lines) that receives feedback from a receiver 118 based on a radio signal sent to the receiver 118 from the transmitter 116.

Due at least to implementation and decoding delay constraints, a maximum size of each CB 104 may be much smaller than the size of one TB 102. For example, the maximum size of one CB 104 may be substantially 6144 bits, and the maximum size of one TB 102 may be substantially 75 k bits. Accordingly, one TB 102 may contain multiple CBs 104 (e.g., 12 CBs 104).

The HARQ scheme may also include rate-matching (RM) 106 according to a specified redundancy version (RV) on the coded bits of each CB 104. RM may be performed to fit information into allocated physical resources (e.g., bandwidth). The bits after rate-matching 106 may be concatenated 108, interleaved 108, and/or modulated and finally transmitted via radio signals (e.g., information signals, which may be information coded onto radio signals).

At the receiving side of a transmission under the HARQ scheme (e.g., a receiver of the transmitted radio signals), a reverse procedure is done after receiving radio signals at the receiver 118. This reverse procedure may include demodulation, de-interleaving, and de-rate-matching. The reverse procedure may be performed to obtain soft bits which may be split into multiple segments. Each segment may correspond to one CB. Also, each CB may be decoded independently based on its own soft bits input.

In the HARQ scheme, if all CBs 104 of one TB 102 are correctly decoded, which means the TB 102 is correctly received, then the receiver 118 (e.g., the receiver of the transmitted radio signals) may send an acknowledgement (ACK) back for each TB 102 to the transmitter 116 (e.g., the transmitter of the transmitted radio signals (e.g., information signals)); otherwise, a non-acknowledgement (NAK) is sent. When the transmitter 116 gets NAK feedback from the receiver 118, the transmitter 116 will retransmit the TB 102 in the specified RV once again. The receiver 118 may combine the soft bits in the previous transmission with the soft bits in the retransmission, and perform decoding.

As discussed above, the HARQ scheme may be utilized for data retransmission. However, changes may be made to current data retransmission schemes as users continue to demand higher and higher data rates. Therefore, there is a desire for improved methods of data retransmission.

### SUMMARY OF THE INVENTION

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the invention.

In one embodiment, a method performed by a first communication node includes: transmitting a first signal, the first signal comprising a transport block comprising a plurality of coding blocks; receiving a feedback signal, the feedback signal associated with a plurality of groups, each of the groups in the plurality of groups comprising at least one of the coding blocks; and puncturing at each of the groups in accordance with the feedback signal to produce a plurality of punctured groups.

In a further embodiment, a method performed by a first communication node includes: receiving a first signal, the first signal comprising a transport block comprising a plurality of coding blocks; determining puncturing for a plurality of groups, each of the groups in the plurality of groups comprising at least one of the coding blocks; sending a feedback signal that indicates the puncturing; and receiving a second signal comprising each of the groups in the plurality of groups punctured in accordance with the feedback signal.

In another embodiment, a first communication node includes: a transmitter configured to: transmit a first signal, the first signal comprising a transport block comprising a plurality of coding blocks; a receiver configured to: receive a feedback signal, the feedback signal associated with a plurality of groups, each of the groups in the plurality of groups comprising at least one of the coding blocks; and at least one processor configured to: puncture at each of the groups in accordance with the feedback signal to produce a plurality of punctured groups.

In yet another embodiment, a first communication node includes: a receiver configured to: receive a first signal, the first signal comprising a transport block comprising a plurality of coding blocks; at least one processor configured to: determine puncturing for a plurality of groups, each of the groups in the plurality of groups comprising at least one of the coding blocks; a transmitter configured to: send a feedback signal that indicates the puncturing; wherein the receiver is configured to: receive a second signal comprising each of the groups in the plurality of groups punctured in accordance with the feedback signal.

### BRIEF DESCRIPTION OF THE DRAWINGS

Various exemplary embodiments of the invention are described in detail below with reference to the following Figures. The drawings are provided for purposes of illustration only and merely depict exemplary embodiments of the invention to facilitate the reader's understanding of the invention. Therefore, the drawings should not be considered limiting of the breadth, scope, or applicability of the invention. It should be noted that for clarity and ease of illustration these drawings are not necessarily drawn to scale.

FIG. 1 is a block diagram that illustrates principles of the HARQ data retransmission scheme (also termed more simply as a “HARQ scheme”).

FIG. 2 illustrates an exemplary cellular communication network in which techniques disclosed herein may be implemented, in accordance with various embodiments of the present disclosure.

FIG. 3 illustrates block diagrams of an exemplary base station and user equipment device, in accordance with some embodiments of the invention.

FIG. 4 is a simulation result that illustrates a block error rate of a transport block plotted against a number of coding blocks, in accordance with some embodiments.

FIG. 5 is a block diagram illustrating robust data retransmission using a retransmission configuration table index (RCTI), in accordance with some embodiments.

FIG. 6 is a block diagram illustrating robust data retransmission using an aggregated signal, in accordance with some embodiments.

### DETAILED DESCRIPTION OF EXEMPLARY EMBODIMENTS

Various exemplary embodiments of the invention are described below with reference to the accompanying figures to enable a person of ordinary skill in the art to make and use the invention. As would be apparent to those of ordinary skill in the art, after reading the present disclosure, various changes or modifications to the examples described herein can be made without departing from the scope of the invention. Thus, the present invention is not limited to the exemplary embodiments and applications described and illustrated herein. Additionally, the specific order or hierarchy of steps in the methods disclosed herein are merely exemplary approaches. Based upon design preferences, the specific order or hierarchy of steps of the disclosed methods or processes can be re-arranged while remaining within the scope of the present invention. Thus, those of ordinary skill in the art will understand that the methods and techniques disclosed herein present various steps or acts in a sample order, and the invention is not limited to the specific order or hierarchy presented unless expressly stated otherwise.

As described below, the discussion below may refer to functional entities, such as a transmitter, receiver, etc. (either in physical or virtual form), which are similar to those mentioned above with respect to conventional communication systems. As would be understood by persons of ordinary skill in the art, however, such conventional functional entities do not perform the functions described below, and therefore, would need to be modified or specifically configured to perform one or more of the operations described below. Additionally, persons of skill in the art would be enabled to configure functional entities to perform the operations described herein after reading the present disclosure. The term “configured” as used herein with respect to a specified operation or function refers to a system, device, component, circuit, structure, machine, etc. that is physically or virtually constructed, programmed and/or arranged to perform the specified operation or function.

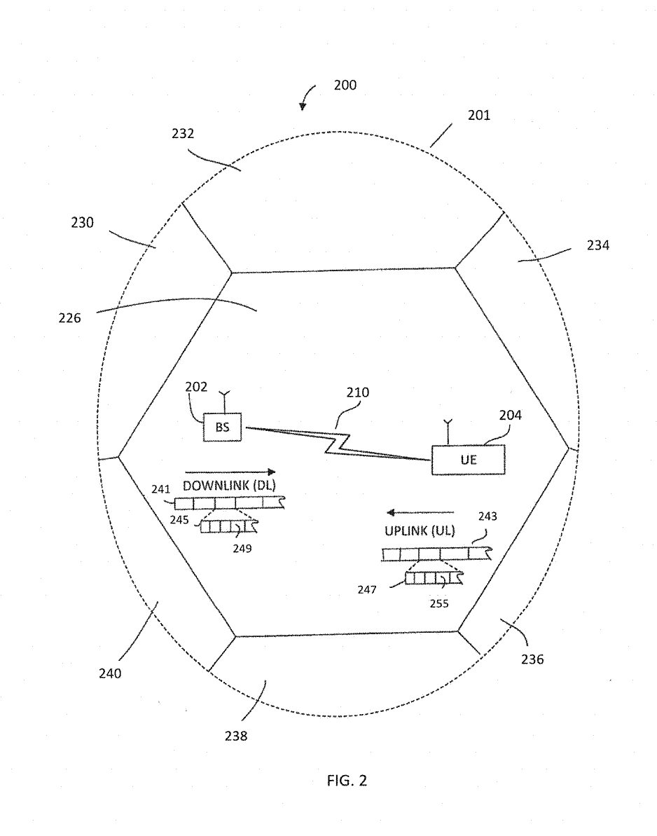

FIG. 2 illustrates an exemplary wireless communication network 200 in which techniques disclosed herein may be implemented, in accordance with an embodiment of the present disclosure. The exemplary communication network 200 may overlay a geographic area 201 and include a base station (BS) 202 and a user equipment (UE) device 204 that can communicate with each other via a communication link 210 (e.g., a wireless communication channel), and a cluster of notional cells 226, 230, 232, 234, 236, 238 and 240. In FIG. 2, the BS 202 and UE 204 are contained within the geographic boundary of cell 226. Each of the other cells 230, 232, 234, 236, 238 and 240 may include at least one base station (BS) operating at its allocated bandwidth to provide adequate radio coverage to its intended users. For example, the BS 202 may operate at an allocated channel transmission bandwidth to provide adequate coverage to the UE 204. The BS 202 and the UE 204 may communicate via a downlink radio frame 241, and an uplink radio frame 243 respectively. Each radio frame 245/247 may be further divided into sub-frames 249/251 which may include data symbols 253/255.

In the present disclosure, the base station (BS) 202 and user equipment (UE) 204 are described herein as non-limiting examples of “communication nodes,” generally, which can practice the methods disclosed herein. Such communication nodes may be capable of wireless and/or wired communications, in accordance with various embodiments of the invention. Each of these communication nodes may be a transmitter in one situation and a receiver in another situation. For example, a BS 202 may transmit to a UE 204, such as during a downlink (DL), discussed further below. Therefore, the BS 202 may be a transmitter and the UE 204 may be a receiver. However, in another situation (such as during an uplink (UL), described further below) the UE 204 may be a transmitter and the BS 202 may be a receiver. Accordingly, both the BS 202 and the UE 204 may be a receiver or a transmitter and execute robust data retransmission in accordance with various embodiments, as will be discussed further below.

In network 200, a signal transmitted from the BS 202 may suffer from environmental and/or operating conditions that cause undesirable channel characteristics, such as Doppler spread, Doppler shift, delay spread, multipath interference, etc. mentioned above. For example, multipath signal components may occur as a consequence of reflections, scattering, and diffraction of the transmitted signal by natural and/or man-made objects. At the receiver antenna 114, a multitude of signals may arrive from many different directions with different delays, attenuations, and phases. Generally, the time difference between the arrival moment of a first received multipath component (typically the line of sight (LOS) component) and the last received multipath component (typically a non-line of sigh (NLOS) component) is called delay spread. The combination of signals with various delays, attenuations, and phases may create distortions such as inter-symbol interference (ISI) and inter-channel interference (ICI) in the received signal. The distortion may complicate reception and conversion of the received signal into useful information. For example, delay spread may cause ISI in the useful information (data symbols) contained in the radio frame 224.

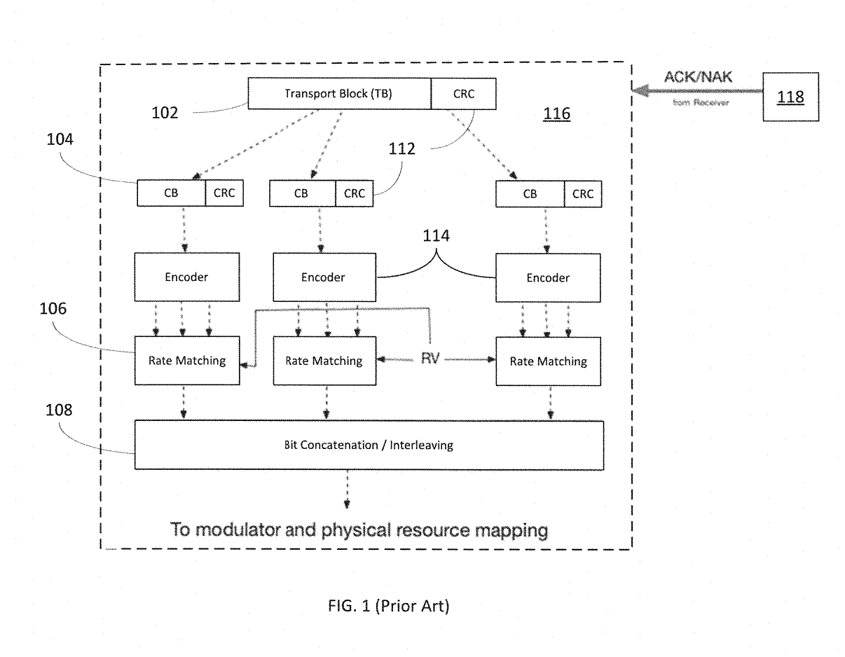

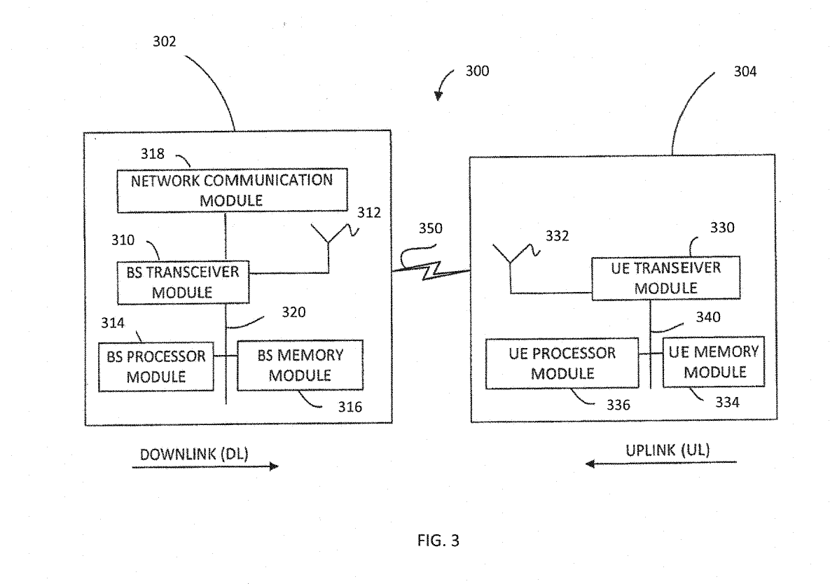

FIG. 3 illustrates block diagrams of an exemplary system 300 including a base station (BS) 302 and user equipment (UE) 304 for transmitting and receiving wireless communication signals, e.g., OFDM/OFDMA signals, between each other. The system 300 may include components and elements configured to support known or conventional operating features that need not be described in detail herein. In one exemplary embodiment, system 300 can be used to transmit and receive data symbols in a wireless communication environment such as the wireless communication environment 200 of FIG. 1, as described above.

The BS 302 includes a BS transceiver module 310, a BS antenna 312, a BS processor module 314, a BS memory module 316, and a network communication module 318, each module being coupled and interconnected with one another as necessary via a data communication bus 320. The UE 304 includes a UE transceiver module 330, a UE antenna 332, a UE memory module 334, and a UE processor module 336, each module being coupled and interconnected with one another as necessary via a data communication bus 340. The BS 302 communicates with the UE 304 via a communication channel (e.g., link) 350, which can be any wireless channel or other medium known in the art suitable for transmission of data as described herein.

As would be understood by persons of ordinary skill in the art, system 300 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present invention.

In accordance with some embodiments, UE transceiver 330 may be referred to herein as an “uplink” transceiver 330 that includes a RF transmitter and receiver circuitry that are each coupled to the antenna 332. A duplex switch (not shown) may alternatively couple the uplink transmitter or receiver to the uplink antenna in time duplex fashion. Similarly, in accordance with some embodiments, the BS transceiver 310 may be referred to herein as a “downlink” transceiver 310 that includes RF transmitter and receiver circuitry that are each coupled to the antenna 312. A downlink duplex switch may alternatively couple the downlink transmitter or receiver to the downlink antenna 312 in time duplex fashion. The operations of the two transceivers 310 and 330 are coordinated in time such that the uplink receiver is coupled to the uplink antenna 332 for reception of transmissions over the wireless transmission link 350 at the same time that the downlink transmitter is coupled to the downlink antenna 312. Preferably there is close time synchronization with only a minimal guard time between changes in duplex direction.

The UE transceiver 330 and the base station transceiver 310 are configured to communicate via the wireless data communication link 350, and cooperate with a suitably configured RF antenna arrangement 312/332 that can support a particular wireless communication protocol and modulation scheme. In some exemplary embodiments, the UE transceiver 608 and the base station transceiver 310 are configured to support industry standards such as the Long Term Evolution (LTE) and emerging 5G and New Radio (NR) standards, and the like. It is understood, however, that the invention is not necessarily limited in application to a particular standard and associated protocols. Rather, the UE transceiver 330 and the base station transceiver 310 may be configured to support alternate, or additional, wireless data communication protocols, including future standards or variations thereof.

In accordance with various embodiments, the BS 302 may be a next generation nodeB (gNodeB or gNB), serving gNB, target gNB, transmission reception point (TRP), evolved node B (eNB), a serving eNB, a target eNB, a femto station, or a pico station, for example. In some embodiments, the UE 304 may be embodied in various types of user devices such as a mobile phone, a smart phone, a personal digital assistant (PDA), tablet, laptop computer, wearable computing device, etc. The processor modules 314 and 336 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 314 and 336, respectively, or in any practical combination thereof. The memory modules 316 and 334 may be realized as RAM memory, flash memory, ROM memory, EPROM memory, EEPROM memory, registers, a hard disk, a removable disk, a CD-ROM, or any other form of storage medium known in the art. In this regard, memory modules 316 and 334 may be coupled to the processor modules 314 and 336, respectively, such that the processors modules 314 and 336 can read information from, and write information to, memory modules 316 and 334, respectively. The memory modules 316 and 334 may also be integrated into their respective processor modules 314 and 336. In some embodiments, the memory modules 316 and 334 may each include a cache memory for storing temporary variables or other intermediate information during execution of instructions to be executed by processor modules 314 and 336, respectively. Memory modules 316 and 334 may also each include non-volatile memory for storing instructions to be executed by the processor modules 314 and 336, respectively.

The network communication module 318 generally represents the hardware, software, firmware, processing logic, and/or other components of the base station 302 that enable bi-directional communication between base station transceiver 310 and other network components and communication nodes configured to communication with the base station 302. For example, network communication module 318 may be configured to support internet or WiMAX traffic. In a typical deployment, without limitation, network communication module 318 provides an 802.3 Ethernet interface such that base station transceiver 310 can communicate with a conventional Ethernet based computer network. In this manner, the network communication module 318 may include a physical interface for connection to the computer network (e.g., Mobile Switching Center (MSC)).

The HARQ scheme, as discussed above, may be based on decoding results from all coding blocks (CB) of a transmission block (TB) together only when all of the CBs are received without error. Accordingly, the acknowledgement (ACK) or non-acknowledgement (NAK) indications may be produced on a TB basis, rather than a CB basis. Therefore, even if only one CB is decoded incorrectly, and the rest of the CBs of a TB are decoded correctly, a NAK may be sent back to the transmitter for retransmission of the entire TB (and the originally correctly transmitted CBs). The HARQ scheme, or protocol, has led to system designs in which rate matching modules in all CBs are identical since individual CBs are not distinguished from one another. In such designs, the rate matching modules all have the same parameters such as the number of input bits, the number of output bits, RV values, etc.

However, an inherent waste occurs with the HARQ scheme because if only one CB in a TB is incorrectly received, all of the CBs of the TB are re-transmitted with the same rate-matching configuration, including the CBs that were previously transmitted correctly. This waste unnecessarily increases the resource demand to achieve an effective decoding error rate of each CB, and may waste transmission power. This waste may also impacts network performance by generating unnecessary interference in the network.

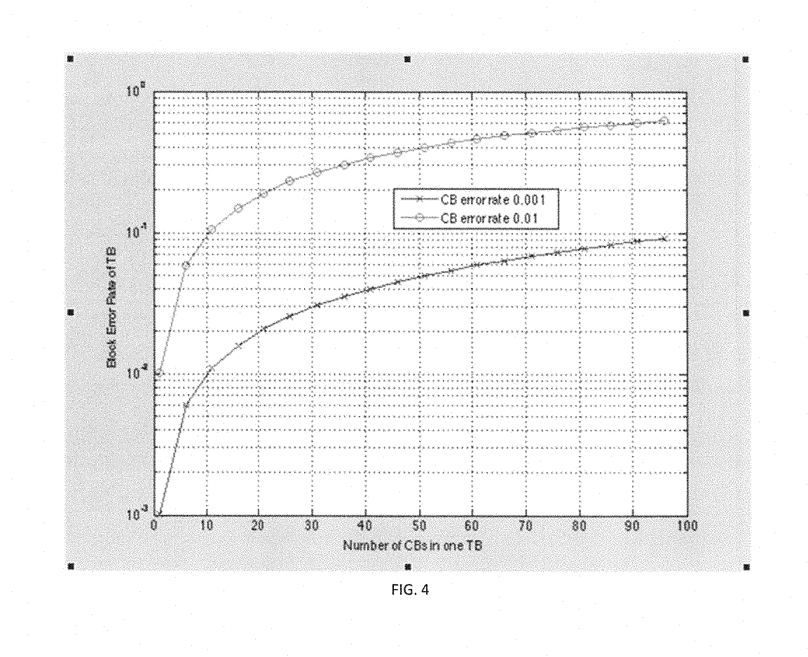

FIG. 4 is a simulation result that illustrates how the TB error rate changes with the number of CBs with certain CB error rates. The number of CBs in one TB are illustrated on the X axis and a block error rate of the TBs are illustrated on the Y axis. The block error rate of a TB equals 1−(1−Pₑ)^{N}, where Pₑ is the decoding error rate for one CB, and N is the number of CBs in one TB. As illustrated, the CB error rate at 0.001 and 0.01 are roughly parallel to each other. Therefore, there may be an improvement in error rate with a corresponding change in the granularity of the CBs in a TB (e.g., where the error rate decreases exponentially as the number of CBs in a TB decreases).

Accordingly, a consideration for current retransmission feedback (e.g., ACK/NAK signal) design is to minimize the overhead (e.g., cost) of feedback signaling. For example, in LTE, one bit of a ACK/NAK signal pair for each data stream may cost (e.g., expend in resource overhead) only 1 kbps. However, an ACK/NAK pair generated (e.g., produced) based on each CB may cost 12 kbps for each data stream. This means that there may be a resource overhead cost of almost 100 kbps (8*12 kpbs) for an 8-stream data transmission. This is not favorable in radio link design.

Accordingly, systems and methods in accordance with various embodiments may provide robust data retransmissions that organizes data retransmissions with greater granularity than the TB level (e.g., below the TB level). This additional level of granularity in data retransmissions may avoid the inherent waste of current retransmission mechanisms (e.g., the HARQ scheme discussed above) while maintaining an acceptable signaling overhead cost.

In certain embodiments, CBs may be grouped into CB groups that are smaller (e.g., includes less bits) than a TB, from which the groups of CBs may constitute at least one TB. A gravity value may be assigned for the CB groups that provide information on a relative amount of incorrectly decoded CBs in each CB group. A higher gravity value means there are more incorrectly decoded CBs in a particular group. Stated another way, a higher gravity value means that more constituent bits are incorrectly received. A higher gravity value may have lower puncturing, which means that more of the incorrectly received bits are retransmitted. This also means that less of the correctly transmitted bits are retransmitted, and thus resources that would have been expended on retransmitting correctly transmitted bits may be conserved.

For example, one TB may contains N_{cb} CBs, and these Nₜₕ CBs may be further divided into N_{G} groups, where N_{cb} and N_{G} are each predetermined positive integers. At the receiver side, a gravity value may be counted for each group based on a Cyclic Redundancy Check (CRC) checksum result of each CB in a particular group. Thus, a total of N_{G} gravity values can be obtained for each TB transmission. For example, when N_{G}=N_{cb}, the number of CB groups may be equivalent to the number of CBs, such that each CB group may be equivalent to a CB.

In accordance with some embodiments, one principal of operation is that a CB group with a small gravity value can tolerate more “puncture” in a retransmission, which means a higher coding rate or a lower coding gain can be applied on the CB group. In accordance with this principle, the CB groups may be sorted from the highest gravity value down to the lowest gravity value. Thereafter, the transmitter can puncture the least number of bits in the rate matching of the CB with the highest gravity value, and puncture the largest number of bits in the rate matching of the CB with the lowest gravity value. As is known in the art, the term “puncture” refers to a process wherein some of the coded bits in a CB, for example, are discarded and thus not transmitted. An operation that is the opposite of puncturing, is “repetition,” in which some of the coded bits are duplicated in the transmission which will improve the decoding performance. One of the tasks of a rate-matching module is to perform puncturing and/or repetition over the coded bits.

In a further embodiment, a pre-defined table can be provided with each row in the table corresponding to different sorting of CB groups and the preferred parameters for rate matching (e.g., degree of puncturing in accordance with gravity value) for each CB group. After the structure of the table is defined and both the transmitter and receiver have access to the table, the receiver may send a value indicating an index for the table to the transmitter. The index for the table may be referred to herein as a Retransmission Configuration Table Index (RCTI) which provides the sorting results based on the decoding results for each CB group, as discussed above. For example, a first index (e.g., “Index 0”) can be equivalent to an ACK, which means that no re-transmission is needed. A second index (e.g., “Index 1”) can define a sorting of CB groups by relative gravity values for purposes of retransmission. In some embodiments, the gravity values have only a relative meaning, thus it is not necessary to define specific gravity values in each row in the pre-defined table.

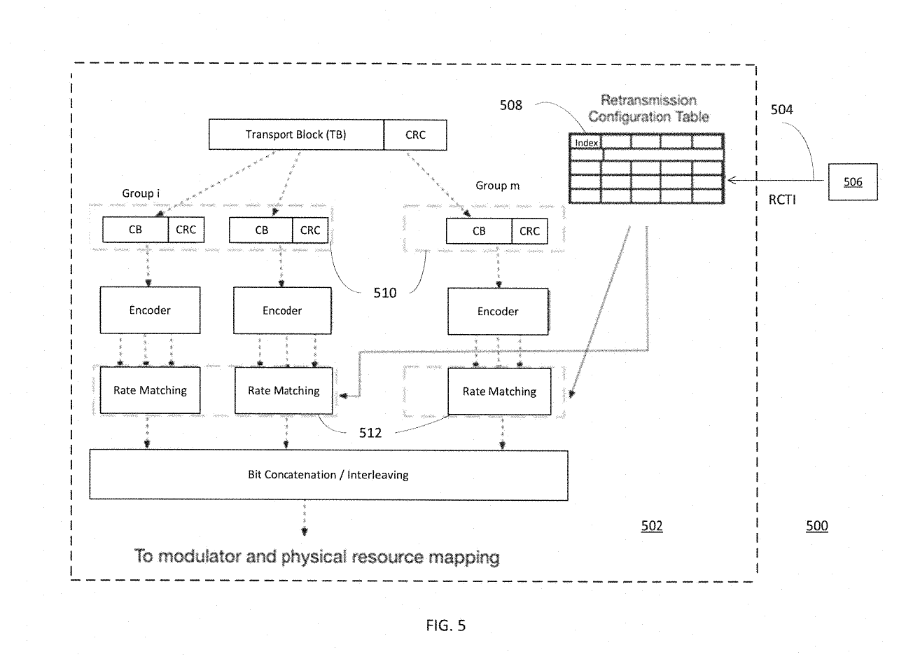

FIG. 5 is a block diagram 500 illustrating robust data retransmission using a retransmission configuration table index (RCTI), in accordance with some embodiments. As shown in FIG. 5, the transmitter 502 (noted conceptually with dotted lines) may receive a non-zero index (RCTI) value 504 from a receiver 506. In response to receiving the RCTI value 504, the transmitter 502 may look up the RCTI value 504 in a predefined table 508 to identify the sorting of CB groups 510 and parameters corresponding to the received RCTI value 504. The transmitter 502 may then configures all of the rate matching modules 512 with the parameters (e.g., amount, or degree, of puncturing) specified in the table 508 by CB group 510. Then retransmission, by the transmitter 502 to the receiver 506, is performed after the configuration is finished. At the receiver 506 side, the retransmission is received with the predefined set of rate matching parameters (e.g., puncturing) for each of the CB groups 510. Various other illustrated components of the block diagram 500 have been discussed above and are not repeated here for brevity.

Table-1 below gives one example for N_{G}=3 in which the table 508 emphasizes the CB group 510 in each sorting pattern having the highest gravity value (i.e., the CB group that will have the lowest puncturing rate), in accordance with one embodiment of the invention. In this example, only 2-bit feedback signaling is needed to specify index values 0 to 3, instead of a 1-bit ACK/NAK.

TABLE 1
Exemplary predetermined table
with high gravity value emphasis

| | | RM | RM | RM |
|---|---|---|---|---|
| | Sorting | Params for | Params for | Params for |
| Index | Pattern | CB Group 0 | CB Group 1 | CB Group 2 |
| 0 | ACK | | | |
| 1 | G0 | RMP_{low}_punc | RMP_{high}_punc | RMP_{high}_punc |
| 2 | G1 | RMP_{high}_punc | RMP_{low}_punc | RMP_{high}_punc |
| 3 | G2 | RMP_{high}_punc | RMP_{high}_punc | RMP_{low}_punc |

In table 1 above, all of the CBs in one TB are divided into three CB groups 510, with each CB group 510 containing multiple CBs. The receiver returning (e.g., transmitting to the transmitter as feedback) an index value associated with of “Index 0” to the transmitter means that all of the CBs in the three CB groups 510 were correctly received and decoded. This index value may also act as an ordinary ACK signal. However, if the receiver returns an index value associated with Index 1, 2 or 3, each of these return values will act as a modified NAK signal, which sorts the 3 CB groups 510 by relative gravity values (i.e., “sorting patterns”).

For example, an index value associated with Index 1 corresponds to sorting pattern “G0,” which instructs the transmitter that CB group 0 has the highest gravity value. Accordingly, CB group 0 may be afforded a lower or the lowest puncturing applied to its coded bits. This may be in contrast to CB groups 1 and 2, which can (relative to CB Group 0) have a normal or higher level of puncturing applied their coded bits. Similarly, for Index 2 and 3, CB groups 1 and 2, respectively, would have the least puncturing relative to other CB groups 510.

In the example of the receiver returning a value corresponding to “Index 1,” it can be anticipated that decoding of CB group 0 can be enhanced. This may mean that a higher coding gain is expected in the retransmission, since the rate matching parameters (input size, output size, redundancy version, etc.) of CB group 0 will have a lower puncturing rate. One exemplary advantage provided by certain embodiments is that the physical resources utilized in the re-transmission of CBs which are correctly or nearly correctly received in the first transmission may be saved. This saving may be in account of applying a relatively higher puncturing rate (i.e., “high punc”) to those CBs (in contrast with a relatively lower puncturing rate, e.g., “low punc.”) Each of “high punc” and “low punc” are indicated in Table 1 and Table 2. This results in more physical resources being available for retransmission of those CB's with relatively higher error rates (i.e., higher gravity values) in the first transmission. Thus, by sorting CB groups 510 by gravity values and adjusting a level of puncturing to one or more CB groups 510 within a TB in accordance with their gravity value, wasted resources and interference can be reduced without significantly degrading link performance, resulting in overall improved network performance.

Table-2 shows another example where the lowest gravity value of the CB group is 0, and all of the coded bits from a CB group 510 having a gravity value of 0 are punctured. Accordingly, more physical resources can be assigned to the rest of the CB groups 510, and higher coding gains can be obtained for the rest of the CB groups 510.

TABLE 2
Exemplary predetermined table with low gravity value emphasis

| | Sorting | RM Params | RM Params | RM Params |
|---|---|---|---|---|
| | Pattern | for | for | for |
| Index | (Lowest value) | Group 0 | Group 1 | Group 2 |
| 0 | ACK | | | |
| 1 | G0(None or zero) | RMP_{high}_punc | RMP_{low}_punc | RMP_{low}_punc |
| 2 | G1(None or zero) | RMP_{low}_punc | RMP_{high}_punc | RMP_{low}_punc |
| 3 | G2(None or zero) | RMP_{low}_punc | RMP_{low}_punc | RMP_{high}_punc |
| 4 | G0(0) | All punctured | RMP_{low}_punc | RMP_{low}_punc |
| 5 | G1(0) | RMP_{low}_punc | All punctured | RMP_{low}_punc |
| 6 | G2(0) | RMP_{low}_punc | RMP_{low}_punc | All punctured |

Table 2 above is similar to Table 1 but emphasizes the CB groups 510 in each sorting pattern having the lowest gravity value (i.e., the CB group 510 that will have the greatest rate or amount of puncturing), in accordance with one embodiment of the invention. If the receiver returns (e.g., feeds back) an index value associated with “Index 0” to the transmitter, this means all of the CBs in the 3 CB groups 510 were correctly received and decoded. This returned (e.g., fed back) index value acts as an ordinary ACK signal. However, if the receiver returns an index value associated with Index 1, 2, 3, 4, 5 or 6, each of these return values will act as a modified NAK signal. The modified NAK signal may sorts the 3 CB groups 510 by relative gravity values (i.e., “sorting patterns”). For example, Index 1 and 4 represent cases where CB group 0 has the lowest gravity value, and CB groups 1 and 2 have relatively higher gravity values. In one embodiment, the puncturing rate of CB groups 1 and 2 are not adjusted when the receiver returns an index value of 1 or 4; rather only the puncturing rate of CB group 0 is increased to free up more resources to be used for retransmitting CB groups 1 and 2. It is appreciated that the difference between Indexes 1-3 and Indexes 4-6 in Table 2 above is that lowest gravity value is non-zero in index 1 and zero in index 4. In index 4 (gravity value=0, which means no decoding errors), all of the coded bits of CB group 0 are removed (i.e., punctured).

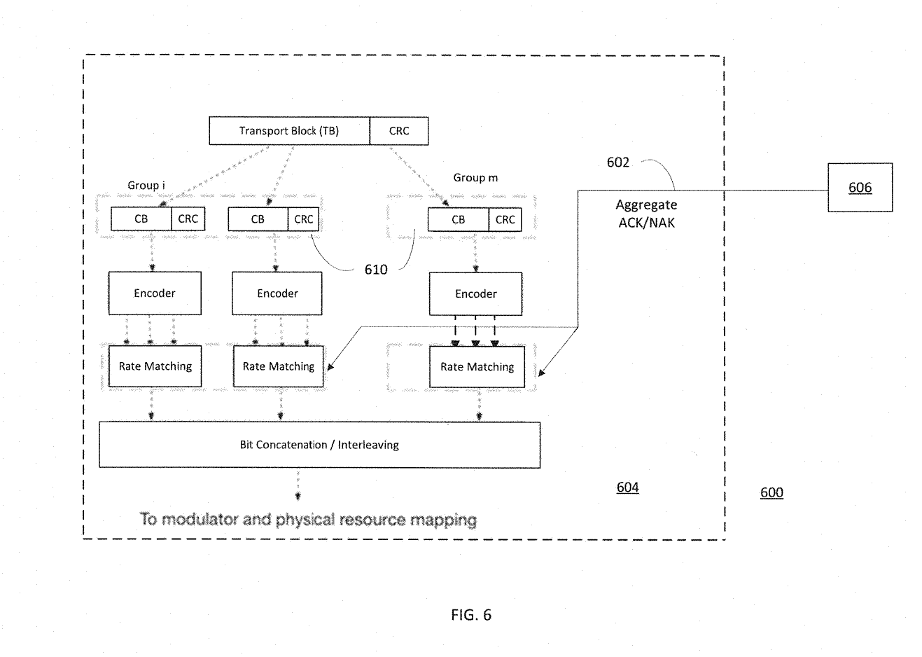

FIG. 6 is a block diagram 600 illustrating robust data retransmission using aggregated feedback (e.g., an aggregated ACK/NAK signal 602) and binary puncturing, in accordance with some embodiments. As shown in FIG. 6, the transmitter 604 (noted conceptually with dotted lines) may receive an aggregated ACK/NAK signal 602 from the receiver 606. The aggregated ACK/NAK signal 602 may be sent in response to (e.g., as feedback for) the receiver 606 receiving an information signal (e.g., radio signal with encoded information, as discussed above). The aggregated ACK/NAK signal 602 may be part of an aggregated feedback signal and be composed of separate acknowledgement signals (e.g., ACK) or non-acknowledgement signals (e.g., NAK). Various other illustrated components of the block diagram 600 have been discussed above and are not repeated here for brevity.

Each of the separate ACK/NAK signals may be associated with a single CB group 610. This means that if all of the code blocks are correctly decoded in CB group I (corresponding to a particular one of the CB groups 610), then the ACK signal may be placed at (e.g., associated with) the position corresponding to CB group i in the aggregated feedback signal (e.g., aggregated ACK/NAK signals 602). Otherwise the NAK is placed in (e.g., associated with) the position corresponding to CB group i in the aggregated feedback signal.

Binary puncturing may be performed based on a CB group's associated ACK or NAK signal. Binary puncturing may refer to whether the CB group 610 is retransmitted or not retransmitted. Specifically, binary puncturing may be performed at the transmitter 604 to either retransmit or not retransmit a particular CB group 610 in accordance with an ACK signal or a NAK signal received from the receiver 606 and associated with the particular CB group 610. For example, CB groups 610 with ACK feedback (e.g., CB groups 610 that are associated with an ACK signal from the aggregated ACK/NAK signals 602), may not be retransmitted. However, CB groups 610 with NAK feedback (e.g., CB groups 610 that are associated with an NAK signal from the aggregated ACK/NAK signals 602), may be retransmitted.

Accordingly, when the transmitter 604 obtains the aggregated ACK/NAK signal 602 from the receiver 606, the transmitter 604 may extract the acknowledgement signal or non-acknowledgement signal (e.g., ACK or NAK) for each CB group 610 and perform binary puncturing in accordance with the aggregated ACK/NAK signal 602. Therefore, for the same size of physical resources allocated for retransmission, those CB groups with NAK feedback may now have more physical resources for retransmission, resulting in a higher coding gain.

While various embodiments of the invention have been described above, it should be understood that they have been presented by way of example only, and not by way of limitation. Likewise, the various diagrams may depict an example architectural or configuration, which are provided to enable persons of ordinary skill in the art to understand exemplary features and functions of the invention. Such persons would understand, however, that the invention is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the invention.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A method performed by a first communication node, the method comprising:
transmitting a first signal, the first signal comprising a transport block comprising a plurality of coding blocks;
receiving a feedback signal, the feedback signal associated with a plurality of groups, each of the groups in the plurality of groups comprising at least one of the coding blocks; and
puncturing at each of the groups in accordance with the feedback signal to produce a plurality of punctured groups.

2. The method of claim 1, wherein the feedback signal comprises a value that indicates a degree of puncturing for each of the plurality of groups.

3. The method of claim 2, wherein the value is associated with a sorting pattern that indicates a relative amount of puncturing among the groups of the plurality of groups.

4. The method of claim 2, wherein the degree of puncturing is performed as a step change, wherein the step change comprises a high degree of puncturing and a low degree of puncturing different than the high degree of puncturing.

5. The method of claim 1, wherein the feedback signal indicates whether binary puncturing is to be performed at each of the groups.

6. The method of claim 1, comprising transmitting a second signal comprising the plurality of punctured groups to a second communication node that sent the feedback signal.

7. The method of claim 1, wherein the feedback signal indicates that a group is not to be retransmitted.

8. A method performed by a first communication node, the method comprising:
receiving a first signal, the first signal comprising a transport block comprising a plurality of coding blocks;
determining puncturing for a plurality of groups, each of the groups in the plurality of groups comprising at least one of the coding blocks;
sending a feedback signal that indicates the puncturing; and
receiving a second signal comprising each of the groups in the plurality of groups punctured in accordance with the feedback signal.

9. The method of claim 8, wherein the feedback signal comprises a value that indicates the puncturing for each of the plurality of groups.

10. The method of claim 9, wherein the value is associated with a sorting pattern that indicates a relative amount of puncturing among the groups of the plurality of groups.

11. The method of claim 9, wherein the puncturing is indicated as a step change, wherein the step change comprises a high degree of puncturing and a low degree of puncturing different than the high degree of puncturing.

12. The method of claim 8, wherein the feedback signal indicates whether binary puncturing is to be performed at each of the groups.

13. The method of claim 8, comprising receiving the second signal from a second communication node that sent the first signal.

14. The method of claim 8, wherein puncturing is performed by at least one rate matching modules associated with the plurality of coding blocks.

15. A first communication node, comprising:
transmitter configured to:
transmit a first signal, the first signal comprising a transport block comprising a plurality of coding blocks;
a receiver configured to:
receive a feedback signal, the feedback signal associated with a plurality of groups, each of the groups in the plurality of groups comprising at least one of the coding blocks; and
at least one processor configured to:
puncture at each of the groups in accordance with the feedback signal to produce a plurality of punctured groups.

16. The first communication node of claim 15, wherein the feedback signal comprises a value that indicates a degree of puncturing for each of the plurality of groups.

17. The first communication node of claim 16, wherein the value is associated with a sorting pattern that indicates a relative amount of puncturing among the groups of the plurality of groups.

18. The first communication node of claim 16, wherein the degree of puncturing is performed as a step change, wherein the step change comprises a high degree of puncturing and a low degree of puncturing different than the high degree of puncturing.

19. The first communication node of claim 15, wherein the feedback signal indicates whether binary puncturing is to be performed at each of the groups.

20. The first communication node of claim 15, wherein the transmitter is configured to transmit a second signal comprising the plurality of punctured groups to a second communication node that sent the feedback signal.

21. The first communication node of claim 15, wherein each coding block is associated with a single rate matching module.

22. A first communication node, comprising:
a receiver configured to:
receive a first signal, the first signal comprising a transport block comprising a plurality of coding blocks;
at least one processor configured to:
determine puncturing for a plurality of groups, each of the groups in the plurality of groups comprising at least one of the coding blocks;
a transmitter configured to:
send a feedback signal that indicates the puncturing;
wherein the receiver is configured to:
receive a second signal comprising each of the groups in the plurality of groups punctured in accordance with the feedback signal.

23. The first communication node of claim 22, wherein the feedback signal comprises a value that indicates the puncturing for each of the plurality of groups.

24. The first communication node of claim 23, wherein the value is associated with a sorting pattern that indicates a relative amount of puncturing among the groups of the plurality of groups.

25. The first communication node of claim 23, wherein the puncturing is indicated as a step change, wherein the step change comprises a high degree of puncturing and a low degree of puncturing different than the high degree of puncturing.

26. The first communication node of claim 22, wherein the feedback signal indicates whether binary puncturing is to be performed at each of the groups.

27. The first communication node of claim 22, wherein the receiver is configured to receive the second signal from a second communication node that sent the first signal.

28. The first communication node of claim 22, wherein the transport block is associated with a single sub frame and comprises each of the groups in the plurality of groups punctured in accordance with the feedback signal.
